(19) United States
(12) Patent Application Publication
(10) Pub. No.: US 2019/0009367 A1
(43) Pub. Date: Jan. 10, 2019

(54) METHOD OF MANUFACTURING PRESS FORMED PRODUCT

(71) Applicant: TOA Industries Co., Ltd., Ota-shi (JP)

(72) Inventors: Yasutaka SUZUKI, Ota-shi (JP); Tadashi IWANUMA, Isesaki-shi (JP); Ken-ichiro MORI, Takarazuka-shi (JP); Yuki NAKAGAWA, Toyohashi-shi (JP)

(73) Assignee: TOA Industries Co., Ltd., Ota-shi (JP)

(21) Appl. No.: 16/014,439

(22) Filed: Jun. 21, 2018

(30) Foreign Application Priority Data
Jul. 4, 2017 (JP) 2017-131342

(51) Int. Cl. B23K 26/32; B21D 22/20; B21D 35/00; B62D 25/04; B62D 29/00

(52) U.S. Cl. CPC B23K 26/32; B21D 22/208; B21D 22/022; B62D 25/04; B62D 29/007; B21D 35/007

(57) ABSTRACT

The invention provides manufacturing a partially reinforced press formed product with high corrosion resistance and antirust property without grain boundary cracks due to spot welding. First and second galvanized steel plates are heated to an austenite range temperature to transform the bodies of the first and second galvanized steel plates into austenite and form a zinc oxide film and a Fe—Zn solid solution phase on the surfaces of the first and second galvanized steel plates. Hot press forming is then performed to the first and second galvanized steel plates which are heated in the process mentioned above, the first and second galvanized steel plates being superposed. The first and second galvanized steel plates, which are hot press formed, are then welded.

### CROSS-REFERENCE TO RELATED APPLICATIONS

This application claims priority from Japanese Patent Application No. 2017-131342, filed Jul. 4, 2017, the content of which is incorporated herein by reference in its entirety.

### FIELD OF THE INVENTION

The invention relates to a method of manufacturing a press formed product, particularly, to a method of manufacturing a press formed product which is partially reinforced with a reinforcement steel plate.

### BACKGROUND OF THE INVENTION

Conventionally, a press formed product which is formed of a base steel plate partially reinforced with a reinforcement steel plate is used in a vehicle structure for the safety of an occupant in an event of vehicle impact.

Japanese Patent Application Publication No. 2014-193712 describes a method of manufacturing a press formed product which is partially reinforced by forming a combined steel plate by superposing a reinforcement steel plate on a base steel plate in a region to be reinforced and spot-welding the superposed portion and by performing hot press forming to this combined steel plate.

Hot press forming is a press technique of heating a steel plate to an austenite range temperature at high temperature and pressing it with dies, in which the steel plate is quenched with the dies by rapid cooling effect, thereby largely enhancing the tensile strength of the steel plate.

It is also known that a galvanized steel plate is used as a member in order to prevent scale formation due to high temperature heating in hot press forming and enhance the corrosion resistance and antirust property.

Applying a galvanized steel plate to a method of manufacturing a press formed product described in Japanese Patent Application Publication No. 2014-193712 would provide a press formed product which is formed with a zinc oxide film and a Fe—Zn solid solution phase on the surfaces of the steel plates in high temperature heating, having high corrosion resistance and antirust property and being partially reinforced.

However, it is likely that such a manufacturing method causes cracks called “grain boundary cracks” near a spot welded portion at a bended portion of a steel plate in hot press forming. It is conceivably because zinc converted to liquid form by rapid heating in spot welding enters the body of the steel plate (Fe) to make the structure of the steel plate fragile.

Furthermore, there is also a problem that a steel plate shears near a spot welded portion due to sliding stress by hot press forming.

### SUMMARY OF THE INVENTION

To address the problems described above, a method of manufacturing a press formed product of the invention includes: heating first and second galvanized steel plates to an austenite range temperature so as to transform bodies of the first and second galvanized steel plates into austenite and form a zinc oxide film and a Fe—Zn solid solution phase on surfaces of the first and second galvanized steel plates; performing hot press forming to the first and second galvanized steel plates heated in the process mentioned above, the first and second galvanized steel plates being superposed without welded; and welding the first and second galvanized steel plates which are hot press formed.

### BRIEF DESCRIPTION OF THE DRAWINGS

FIG. 1 is a schematic diagram of a heating process of first and second galvanized steel plates.

FIG. 2 is a cross-sectional view of the first and second galvanized steel plates.

FIG. 3 is a perspective view showing a superposed state of the first and second galvanized steel plates.

FIG. 4A and FIG. 4B are cross-sectional views showing hot press forming.

FIG. 5 is a cross-sectional view of a press formed product.

FIG. 6 is a perspective view of the press formed product.

### DETAILED DESCRIPTION OF THE INVENTION

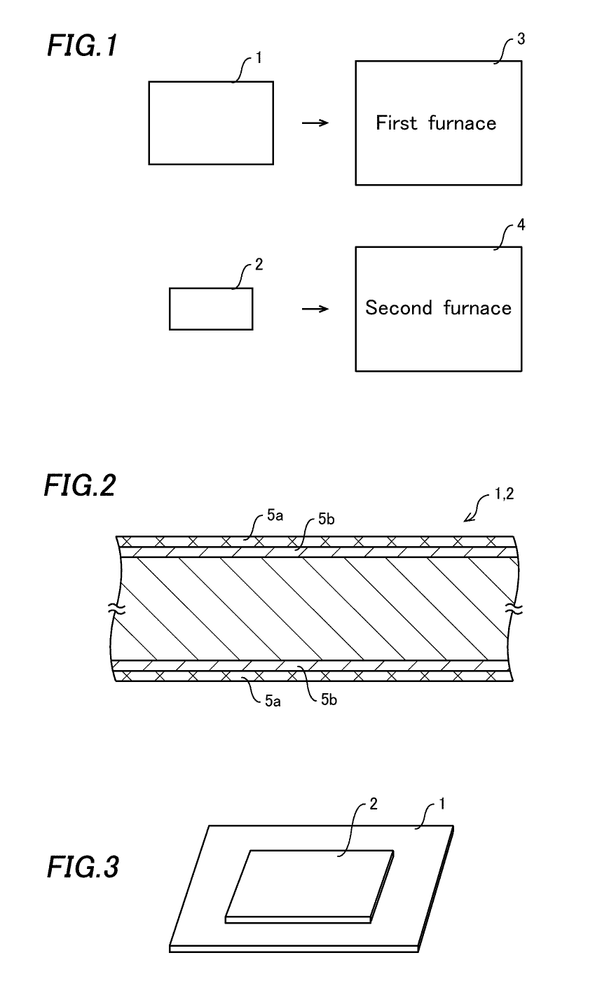

An embodiment of the invention will be described referring to figures. First, as shown in FIG. 1, first and second galvanized steel plates 1, 2 are heated to an austenite range temperature TO by first and second furnaces 3, 4 respectively to transform the bodies of the first and second galvanized steel plates 1, 2 into austenite. The first galvanized steel plate 1 is a base steel plate, and the second galvanized steel plate 2 is a reinforcement steel plate.

Heating the first and second galvanized steel plates 1, 2 by the first and second furnaces 3, 4 respectively is preferable to properly control the respective heating amounts of both the steel plates. It is also preferable not to superpose the first and second galvanized steel plates 1, 2 in the heating process for forming a zinc oxide film 5a and a Fe—Zn solid solution phase 5b on the whole surfaces of the first and second galvanized steel plates 1, 2 uniformly.

By the heating process described above, as shown in FIG. 2, the galvanizing film of the first and second galvanized steel plates 1, 2 is oxidized to form the zinc oxide film 5a with high corrosion resistance and antirust property on the surfaces and the Fe—Zn solid solution phase 5b having a thickness of 20-30 μm thereunder. About 70% Zn of the initial amount remains in the Fe—Zn solid solution phase 5b.

The austenite range temperature TO is, for example, about 900° C., although it differs depending on the carbon contents of the first and second galvanized steel plates 1, 2. Galvanizing includes hot dip galvanizing, electro-galvanizing, and so on.

Next, the first and second galvanized steel plates 1, 2 are taken out from the first and second furnaces 3, 4 simultaneously. The second galvanized steel plate 2 is then superposed on the first galvanized steel plate 1 in a region to be reinforced after the heating process, as shown in FIG. 3. In the embodiment, the whole second galvanized steel plate 2 is disposed within the area region of the first galvanized steel plate 1 in a planar view. These steel plates are not welded in this step.

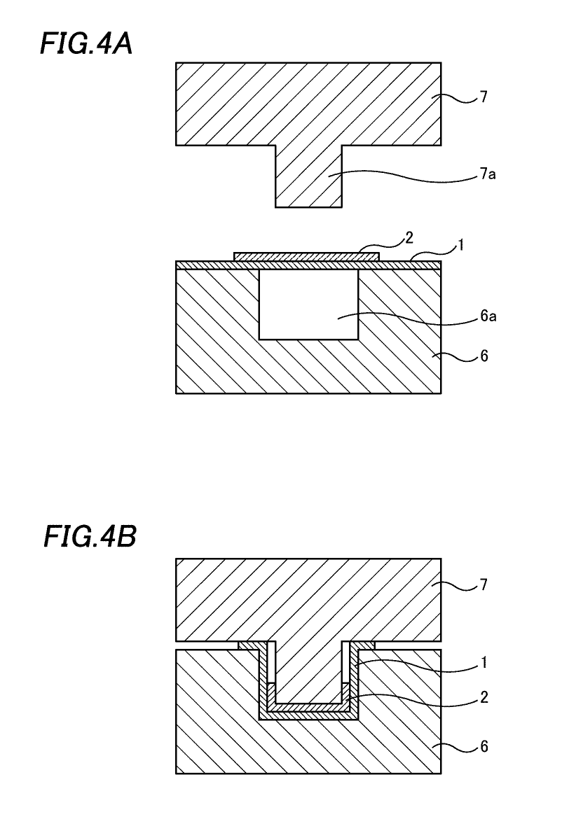

Then, hot press forming is performed to the first and second galvanized steel plates 1, 2 in the superposed state, as shown in FIG. 4A and FIG. 4B.

As shown in the figures, a hot press forming machine is provided, which has an upper die 7 having a convex portion 7a disposed above a lower die 6 having a concave portion 6a, the convex portion 7a being to be engaged with the concave portion 6a. As shown in FIG. 4A, the first and second galvanized steel plates 1, 2 are set on the lower die 6, and the upper die 7 is moved downward to press the first and second galvanized steel plates 1, 2 between the lower die 6 and the upper die 7, thereby performing the rapid cooling and press forming of the first and second galvanized steel plates 1, 2 simultaneously, as shown in FIG. 4B.

Since the first and second galvanized steel plates 1, 2 are rapidly cooled from the austenite range temperature, martensite transformation occurs and quenching is achieved.

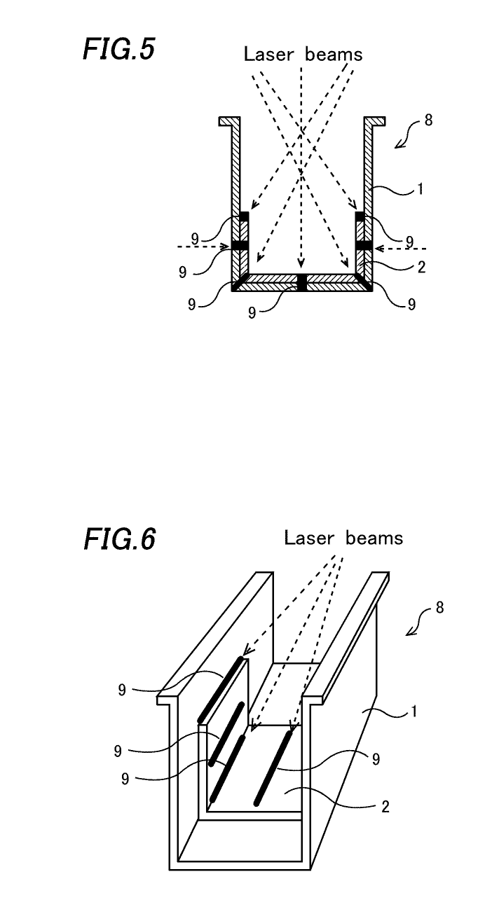

The dies are then opened, and a press formed product 8 shown in FIG. 5 and FIG. 6 is taken out. By this hot press forming, the first and second galvanized steel plates 1, 2 forming the press formed product 8 have highly enhanced tensile strengths of, for example, 1500 MPa, and the superposed portion of these is reinforced with the two steel plates of high tensile strengths.

The first galvanized steel plate 1 and second galvanized steel plate 2 forming the press formed product 8 are then welded. In this case, since the press formed product 8 often has a complex three-dimensional shape such as a U-shape cross-section, for example, it is preferable to use laser welding which has more flexibility in welding portions rather than spot welding.

In the case of laser welding, as shown in FIG. 5 and FIG. 6, for example, preferably, a laser beam shown by a broken line is applied to the bottom portion, the sidewalls, the bottom corner portions or the end portions of the press formed product 8 and beam scanning is performed as appropriate, thereby melting the first galvanized steel plate 1 and the second galvanized steel plate 2 partially and forming welded portions 9. In this case, the welding shape is not necessarily limited to the linear shape.

As described above, since the manufacturing method of the embodiment performs hot press forming in the state where spot welding is not performed, the partially reinforced press formed product 8 with high corrosion resistance, high antirust property and high weldability is manufactured without grain boundary cracks due to spot welding.

Furthermore, the first and second galvanized steel plates 1, 2 are superposed but not spot welded in hot press forming, and the welding is performed after the hot press forming. This prevents a problem that steel plates shear near a spot welded portion due to sliding stress by hot press forming.

It is noted that heating the first and second galvanized steel plates 1, 2 by respective furnaces and not superposing the first and second galvanized steel plates 1, 2 in the heating process are not essential for obtaining an effect of preventing grain boundary cracks due to the spot welding described above and an effect of preventing the steel plate from shearing near the spot welded portion. The first and second galvanized steel plates 1, 2 may be heated by one furnace, and the first and second galvanized steel plates 1, 2 may be superposed in the heating process.

What is claimed is:

1. A method of manufacturing a press formed product, comprising:
heating first and second galvanized steel plates to an austenite range temperature so as to transform bodies of the first and second galvanized steel plates into austenite and form a zinc oxide film and a Fe—Zn solid solution phase on surfaces of the first and second galvanized steel plates;
performing, after the heating of the first and second galvanized steel plates, hot press forming to the first and second galvanized steel plates while the first and second galvanized steel plates are superposed but not welded; and
welding the first and second galvanized steel plates which are hot press formed.

2. The method of claim 1, wherein the first and second galvanized steel plates are heated by first and second furnaces, respectively.

3. The method of claim 1, wherein the welding comprises laser welding.
